(19) United States
(12) Patent Application Publication
(10) Pub. No.: US 2025/0166622 A1
(43) Pub. Date: May 22, 2025

(54) SYSTEMS AND METHODS FOR END-TO-END SPEECH RECOGNITION TO PROVIDE ACCURATE TRANSCRIPTIONS AND REDUCED LATENCY

(71) Applicant: Suki AI, Inc., Redwood City, CA (US)

(72) Inventors: Jatin Chhugani, Mountain View, CA (US); Ganesh Satish Mallya, Santa Clara, CA (US); Vamsi Reddy Chagari, Milpitas, CA (US); Sudheer Tumu, Santa Clara, CA (US); Nithyanand Kota, Santa Clara, CA (US); Maneesh Dewan, Sunnyvale, CA (US)

(21) Appl. No.: 17/410,556

(22) Filed: Aug. 24, 2021

(51) Int. Cl. G10L 15/187; G10L 15/26

(52) U.S. Cl. CPC G10L 15/187; G10L 15/26

(57) ABSTRACT

Systems and methods for end-to-end speech recognition to provide accurate transcriptions and reduced latency are disclosed. Exemplary implementations may: receive audio information including audio signals; effectuate an acoustic model to determine one or more phonemes based on the audio signals, wherein the acoustic model and a decoder is stored in electronic storage; obtain the corresponding one or more statistical representations for the one or more phonemes as defined by the acoustic model; and effectuate the decoder to determine a first output transcript for the audio information based on the statistical representations.

### FIELD OF THE DISCLOSURE

The present disclosure relates to systems and methods for end-to-end speech recognition to provide accurate transcriptions and reduced latency.

### BACKGROUND

Typically, all functionality of a system is processed or run on a single type of processing unit. While processing on a single type of processing unit may simplify the architecture, this may simultaneously contribute to process latency and increased costs.

### SUMMARY

One aspect of the present disclosure related to end-to-end speech recognition by effectuating an acoustic model and a decoder on graphical processing unit(s) and central processing unit(s), respectively. Audio signals may be included in audio information received. The audio signals may convey sounds uttered by users where the sounds represent words (e.g., a note, a message, a command). The graphical processing unit(s) may include processor(s) that effectuate the acoustic model to determine one or more phonemes based on the audio signals. Based on the one or more phonemes determined, statistical representations corresponding to the one or more phonemes may be obtained. Such phonemes may be stored in electronic storage as included in or in relation to the acoustic model. The central processing unit(s) may include processor(s) that effectuate the decoder to determine an output transcript based on the statistical representations. Thus, the output transcript may accurately correspond to the words utter by the user and may be produced with reduced latency.

One aspect of the present disclosure relates to a system configured for end-to-end speech recognition to provide accurate transcriptions and reduced latency. The system may include one or more hardware processors configured by machine-readable instructions. The instruction components may include one or more of information receiving component, model effectuation component, decoder effectuation component, presentation effectuation component, and/or other instruction components.

Electronic storage may be configured to store at least an acoustic model, a decoder, and/or other information. The acoustic model may be trained to determine and store statistical representations for a plurality of sounds utter by users. Individual ones of the statistical representations may be associated with a phoneme. The decoder may be configured to determine an output transcript based on the statistical representations.

The information receiving component may be configured to receive audio information including audio signals and/or other information. The audio signals may convey sounds that represent words spoken by a user.

The model effectuation component may be configured to effectuate the acoustic model to determine one or more phonemes based on the audio signals. The model effectuation component may be configured to obtain the corresponding one or more statistical representations for the one or more phonemes as defined by the acoustic model.

The decoder effectuation component may be configured to effectuate the decoder to determine output transcripts for the audio information based on the statistical representations. By way of non-limiting illustration, a first output transcript for the audio information may be determined. In some implementations, the output transcript may be presented to the user via a client computing platform.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1A-1B illustrates a system configured for end-to-end speech recognition to provide accurate transcriptions and reduced latency, in accordance with one or more implementations.

FIG. 2 illustrates a method for end-to-end speech recognition to provide accurate transcriptions and reduced latency, in accordance with one or more implementations.

FIG. 3 illustrates an example implementation of the system configured for end-to-end speech recognition to provide accurate transcriptions and reduced latency, in accordance with one or more implementations.

### DETAILED DESCRIPTION

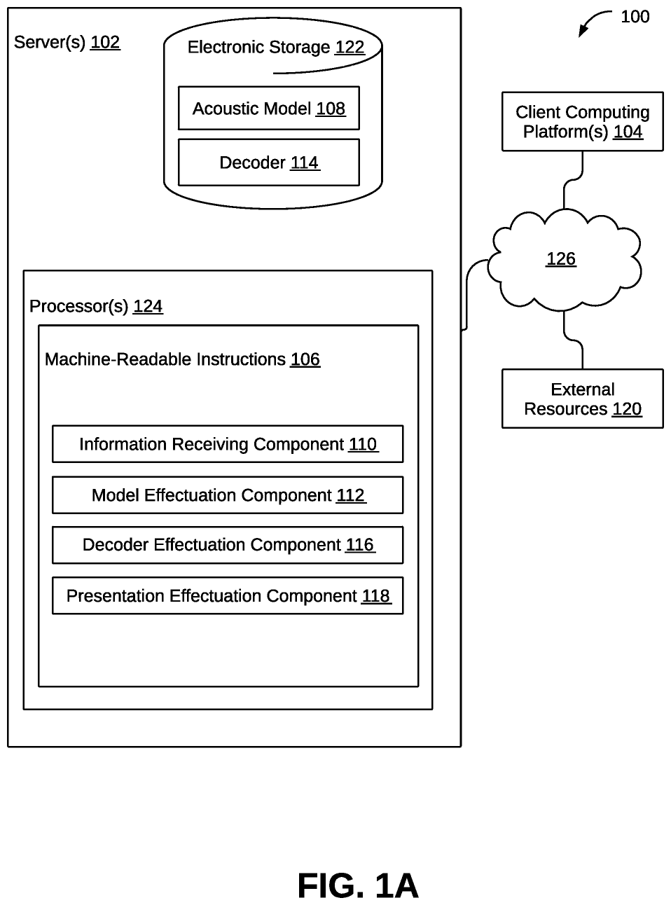

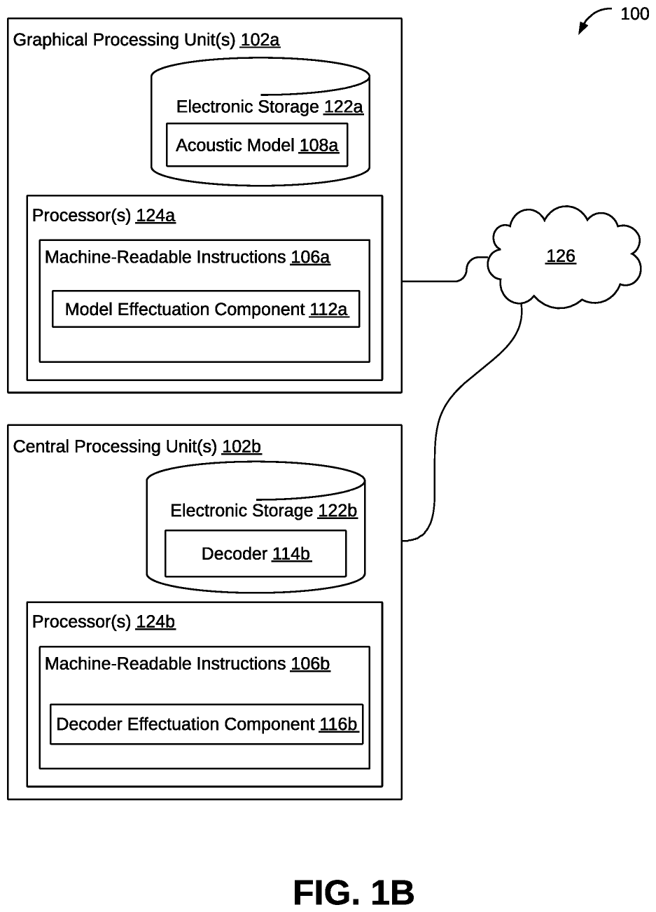

FIG. 1A illustrates a system 100 configured for end-to-end speech recognition to provide accurate transcriptions and reduced latency, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of information receiving component 110, model effectuation component 112, decoder effectuation component 116, presentation effectuation component 118, and/or other instruction components. In some implementations, operations of components 110, 112, 116, 118, and/or other components may be performed all on server(s) 102 illustrated in FIG. 1A, server(s) 102a illustrated in FIG. 1B, and server(s) 102b illustrated in FIG. 1B described herein and communicated with client computing platform(s) 104 according to the peer-to-peer architecture. In some implementations, operations of components 110, 112, 116, 118, and/or other components may be performed partially or completely locally by client computing platform(s) 104.

Electronic storage 122 may be configured to store at least an acoustic model 108, a decoder 114, and/or other information. Acoustic model 108 may be trained to determine and store statistical representations for a plurality of sounds utter by users. In particular, acoustic model 108 may be trained to determine and store the statistical representations for the sounds based on a plurality of audio signals, corresponding transcripts, and/or other information. The audio signals may include a range of hertz (Hz). For example, the range may be from 20 Hz to 20,000 Hz. The audio signals may convey the plurality of sounds. The plurality of sounds may represent words spoken by users. For example, the words spoken by a user may comprise a note (e.g., related to a medical condition of a user, related to a class for school, a to-do list, etc.), a command for execution of an action, a message to another user, among others.

The transcripts may correspond to the plurality of audio signals. The transcripts may include transcripts that resulted from speech recognition techniques described herein or other techniques, transcripts that have been manually corrected by the users (e.g., subsequent to the transcription by way of the speech recognition techniques), manually transcribed transcripts by the users, text that the users generated the audio signals for (e.g., a book and an audiobook), and/or other transcripts.

The statistical representations may refer to numbers and/or other information that represent the sounds in a computable format. That is, the statistical representations may be utilized by other components, processing units, algorithms to effectuate transcriptions that output transcripts. Individual ones of the statistical representations may be associated with a phoneme. Individual phonemes may be a unit of sound that distinguishes a word from other words. A difference in a single phoneme may alter a word and thus a meaning of a statement that a user intends. An amount of phonemes may vary per language.

In some implementations, acoustic model 108 may include Time Depth Separable convolutions, Transformers, other convolution neural networks (CNN), recurrent neural networks (RNN), and/or other machine learning models.

Decoder 114 may be configured to determine an output transcript based on the statistical representations. The output transcript may refer to text that corresponds to audio information received and thus conveys what a user uttered in text. In some implementations, decoder 114 may be based on a lexicon-based beam-search algorithm, power of n-gram language models, Transformers, RNNs, and/or other algorithms. In some implementations, the lexicon may be based on the plurality of transcripts, past output transcripts, and/or other texts. The lexicon and the plurality of transcripts may be stored in the electronic storage 122.

Information receiving component 110 may be configured to receive the audio information including particular audio signals. Such particular audio signals may convey sounds that represent words spoken by a user. In some implementations, the audio information may include a date and/or a time at which the words are spoken by the user (and thus, the audio signals conveyed the sounds), a device from which the audio signals are received from, device information for the device, user information for the user who spoke, and/or other information. The device information may include a device name, a device model, an operating system of the device, a manufacturing date of the device, and/or other information. For example, the device may be client computing platform 104. As another example, the device may be connected, operatively or wirelessly, to client computing platform 104. The user information may include a name of the user, a title of the user (e.g., doctor, attorney, nurse, scribe, etc.), a user identifier, an organization of the user, and/or other user information.

Model effectuation component 112 may be configured to effectuate acoustic model 108 to determine one or more of the phonemes based on the audio signals. In some implementations, a phoneme stream may be determined. In some implementations, a single phoneme may be based on multiple ones of the audio signals. Model effectuation component 112 may be configured to obtain the corresponding one or more statistical representations for the one or more phonemes as defined by acoustic model 108. The obtainment of the corresponding one or more statistical representations may be subsequent to the determination of the one or more phonemes. In some implementations, the operations of model effectuation component 112 may be performed in an ongoing manner until the statistical representations are obtained for all the phonemes determined from the audio signals. The term “ongoing manner” as used herein may refer to continuing to perform an action (e.g., determine, obtain) periodically (e.g., every 30 seconds, every minute, every hour, etc.) or without pause until receipt of an indication to terminate. That is, until the entirety of the audio signals included in the audio information are processed, model effectuation component 112 may perform in an ongoing manner. In some implementations, the indication to terminate may include powering off the device, charging one or more of a battery of the device, resetting the device, detection of an extended pause (e.g., 7 seconds with no utterance), and/or other indications of termination.

Referring to FIGS. 1A and 1B simultaneously, in some implementations, effectuating acoustic model 108 may be performed by one or more processors 124a included in graphical processing unit(s) 102a. Graphical processing unit(s) 102a may include processor(s) 124a, machine-readable instructions 106a, electronic storage 122a, model effectuation component 112a, and/or acoustic model 108a similar to processor(s) 124, machine-readable instructions 106, electronic storage 122, model effectuation component 112, and/or acoustic model 108, respectively, described herein. Acoustic model 108a may be stored in electronic storage 122a. In some implementations, acoustic model 108a may be effectuated by model effectuation component 112a based on the audio signals included in the audio information received by information receiving component 110 of FIG. 1A.

Decoder effectuation component 116 may be configured to effectuate decoder 114 to determine output transcripts based on the statistical representations related to the audio information received. For example, a first output transcript for the audio information based on the statistical representations may be determined by decoder 114. Decoder effectuation component 116 may be configured to store the first output transcript to electronic storage 122. In some implementations, such storage to electronic storage 122 may include the first output transcript in the plurality of transcripts. Thus, acoustic model 108 may further be trained on the output transcripts determined by decoder 114. In some implementations, prior to including the output transcript in the plurality of transcripts that are utilized for training acoustic model 108, the user or other users (e.g., a reviewing user) may review, correct, and/or verify the transcripts resultant of decoder 114.

Effectuating decoder 114 may be performed by one or more processors 124b included in central processing unit(s) 102b. Central processing unit(s) 102b may include processor(s) 124b, machine-readable instructions 106b, electronic storage 122b, decoder effectuation component 116b, and/or decoder 114b similar to processor(s) 124, machine-readable instructions 106, electronic storage 122, decoder effectuation component 116, and/or decoder 114, respectively, described herein. Decoder 114b may be stored in electronic storage 122b. In some implementations, decoder 114b may be effectuated by decoder effectuation component 116b based on the statistical representations obtained by model effectuation component 112a.

Typically, both acoustic model 108 and decoder 114 are effectuated on the same processor(s), such as on graphical processing unit(s) 102a, central processing unit(s) 102b, or server(s) 102. Effectuating both on graphical processing unit(s) 102a may be in resource rich environments where graphical processing unit(s) 102a may perform a plurality of functions. Effectuating both on central processing unit(s) 102b may be in resource scarce scenarios where resources are limited. While running on the same processing unit simplifies the overall system, it may be suboptimal in terms of latencies and/or cost. For example, effectuating acoustic model 108 and decoder 114 in addition to the other operations of system 100 described herein on graphical processing unit(s) 102a may merely provide a 15% increase in processing speed. As another example, a cost of processing may increase two times upon effectuating at least both acoustic model 108 and decoder 114 on central processing unit(s) 102b.

In some implementations described herein, acoustic model 108a may run faster on graphical processing unit(s) 102a, while decoder 114b may run faster on central processing unit(s) 102b. That is, because computation on graphical processing units (GPUs), such as graphical processing unit(s) 102a, may be non-conditional such that satisfying conditions may not be required. Thus, computation of acoustic model 108 may be non-conditional. Furthermore, GPUs typically operate on single-instruction multiple-data (SIMD) basis. SIMD may refer to operation with multiple processing elements to contribute to computation capacity rather than reducing memory access latency. Thus, acoustic model 108a may correspond well or map well to wide SIMD. The wide SIMD may refer to a plurality of the processing elements that facilitate the computation capacity.

Decoder 114b may rely on beam search and/or other algorithms to determine outputs such as the output transcripts. For example, decoder 114b may execute tree traversal and/or decision tree pruning. As such, decoder 114b may execute conditional computation such that satisfaction determination of conditions may be performed. The beam search and/or other algorithms relied on and executed by decoder 114b may be particularly generated for execution on central processing units (CPUs), such as central processing unit(s) 102b, such that the conditional computation may be performed. Conversely, upon decoder 114b running on a GPU, such as graphical processing unit(s) 102a, decoder 114b may run an order of magnitude slower due to lack of support of conditional computation (i.e., non-conditional computation).

Effectuating acoustic model 108a by processor(s) 124a on graphical processing unit(s) 102a and effecting decoder 114b by processor(s) 124b on central processing unit(s) 102b may ensure that graphical processing unit(s) 102a and central processing unit(s) 102b operate in tandem with no significant overhead. System 100 configured in such a manner may result to an 8-9× reduction in overall latency as opposed to graphical processing unit(s) 102a or central processing unit(s) 102b solely running the entire system 100. Furthermore, the overall performance-price ratio may be reduced by about 4.5×. Such performance-price ratio may be significantly lower than the existing state of the art architectures.

Referring to FIG. 1A, presentation effectuation component 118 may be configured to effectuate presentation of the output transcripts, such as the first output transcript, for the audio information. The output transcript may be presented via client computing platform 104 associated with the user. In some implementations, the user and/or the other users may review, correct, and/or verify the transcripts via client computing platform 104 and a user interface thereof.

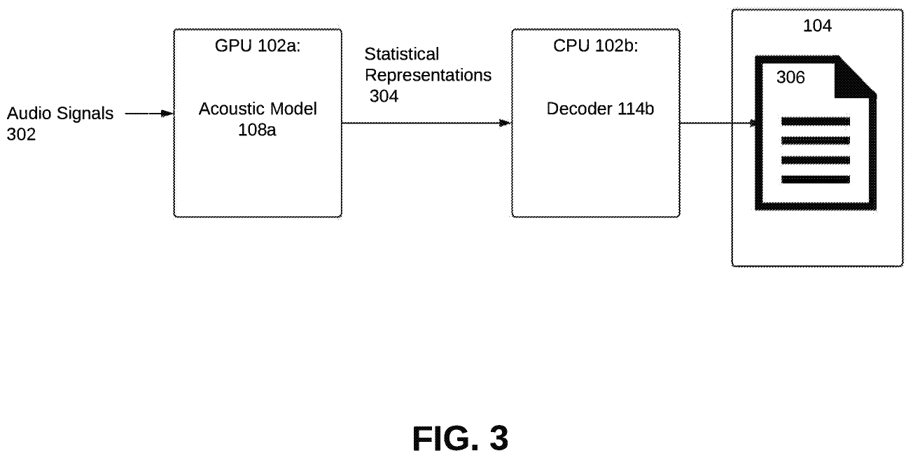

FIG. 3 illustrates an example implementation, in accordance with one or more implementations. FIG. 3 illustrates audio signals 302 as input into acoustic model 108a of graphic processing units (GPU) 102a described in FIG. 1B. Acoustic model 108a may determine statistical representations 304 for phonemes determined by acoustic model 108a. Such statistical representations 304 may be input for decoder 114b of central processing units (CPU) 102b of FIG. 1B. Decoder 114b may determine, based on statistical representations 304, an output transcript 306 that ultimately corresponds to audio signals 302. Output transcript 306 may be presented on client computing platform 104 of FIG. 1A (e.g., tablet) associated with a user that had produced sounds conveyed by audio signals 302.

Referring to FIGS. 1A and 1B, in some implementations, server(s) 102, GPU(s) 102a, CPU(s) 102b, client computing platform(s) 104, and/or external resources 120 may be operatively linked via one or more electronic communication links. For example, such electronic communication links may be established, at least in part, via a network 126 such as the Internet and/or other networks. It will be appreciated that this is not intended to be limiting, and that the scope of this disclosure includes implementations in which server(s) 102, GPU(s) 102a, CPU(s) 102b, client computing platform(s) 104, and/or external resources 120 may be operatively linked via some other communication media.

A given client computing platform 104 may include one or more processors configured to execute computer program components. The computer program components may be configured to enable an expert or user associated with the given client computing platform 104 to interface with system 100 and/or external resources 120, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100.

Server(s) 102 may include electronic storage 122, one or more processors 124, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 122 may comprise non-transitory storage media that electronically stores information. The electronic storage media of electronic storage 122 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from server(s) 102, information received from client computing platform(s) 104, and/or other information that enables server(s) 102 to function as described herein.

Processor(s) 124 may be configured to provide information processing capabilities in server(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute components 110, 112, 112a, 116, 116b, and/or 118, and/or other components. Processor(s) 124 may be configured to execute components 110, 112, 112a, 116, 116b, and/or 118, and/or other components by software; hardware; firmware; some combination of software, hardware, and/or firmware; and/or other mechanisms for configuring processing capabilities on processor(s) 124. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 110, 112, 112a, 116, 116b, and/or 118 are illustrated in FIG. 1 as being implemented within a single processing unit, in implementations in which processor(s) 124 includes multiple processing units, one or more of components 110, 112, 112a, 116, 116b, and/or 118 may be implemented remotely from the other components. The description of the functionality provided by the different components 110, 112, 112a, 116, 116b, and/or 118 described below is for illustrative purposes, and is not intended to be limiting, as any of components 110, 112, 112a, 116, 116b, and/or 118 may provide more or less functionality than is described. For example, one or more of components 110, 112, 112a, 116, 116b, and/or 118 may be eliminated, and some or all of its functionality may be provided by other ones of components 110, 112, 112a, 116, 116b, and/or 118. As another example, processor(s) 124 may be configured to execute one or more additional components that may perform some or all of the functionality attributed below to one of components 110, 112, 112a, 116, 116b, and/or 118.

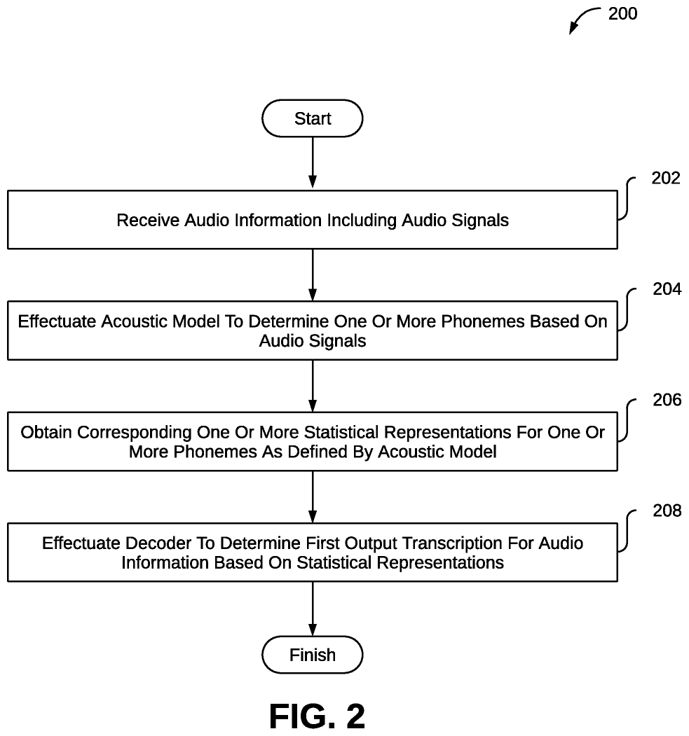

FIG. 2 illustrates a method 200 for end-to-end speech recognition to provide accurate transcriptions and reduced latency, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving audio information including audio signals. The audio signals convey sounds that may represent words spoken by a user. Operation 202 may be performed by one or more hardware processors configured by machine-readable instructions including a component that is the same as or similar to information receiving component 110, in accordance with one or more implementations.

An operation 204 may include effectuating an acoustic model to determine one or more phonemes based on the audio signals. Electronic storage may store the acoustic model and a decoder. The acoustic model may be trained to determine and store statistical representations for a plurality of sounds utter by users. Individual ones of the statistical representations may be associated with a phoneme. The decoder may be configured to determine an output transcript based on the statistical representations. Operation 204 may be performed by one or more hardware processors configured by machine-readable instructions including a component that is the same as or similar to model effectuation component 112, in accordance with one or more implementations.

An operation 206 may include obtaining the corresponding one or more statistical representations for the one or more phonemes as defined by the acoustic model. Operation 206 may be performed by one or more hardware processors configured by machine-readable instructions including a component that is the same as or similar to model effectuation component 112, in accordance with one or more implementations.

An operation 208 may include effectuating the decoder to determine a first output transcript for the audio information based on the statistical representations. Operation 208 may be performed by one or more hardware processors configured by machine-readable instructions including a component that is the same as or similar to decoder effectuation component 116, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system of end-to-end speech recognition configured to provide accurate transcriptions and reduced latency, the system comprising:
electronic storage configured to store at least an acoustic model and a decoder, wherein the acoustic model is trained to determine and store statistical representations for individual sounds uttered by users, wherein individual ones of the statistical representations are numbers that represent individual phonemes in a format computable by at least the decoder, wherein the individual phonemes are units of sound that distinguish individual spoken words from other words spoken by the users, wherein the decoder is configured to determine an output transcript based on the statistical representations; and
one or more processors configured by machine-readable instructions to:
receive audio information including audio signals, wherein the audio signals convey sounds that represent words spoken by a user;
effectuate the acoustic model to determine phonemes present in the sounds conveyed by the audio signals based on the audio signals and subsequently determine statistical representations based on the phonemes such that the statistical representations correspond to the phonemes, wherein the acoustic model is run on a graphical processing unit using non-conditional computation, further wherein the acoustic model being run on the graphical processing unit using the non-conditional computation includes satisfaction of conditions not being required in running the acoustic model on the graphical processing unit;
obtain the corresponding statistical representations from the acoustic model;
effectuate the decoder to determine a first output transcript for the audio information based on the statistical representations, wherein the decoder is run on a central processing unit using conditional computation, further wherein the decoder being run on the central processing unit using the conditional computation includes satisfaction of conditions being required in running the decoder on the central processing unit; and
effectuate presentation of the first output transcript for the audio information via client computing platform associated with the user.

2. (canceled)

3. (canceled)

4. The system of claim 1, wherein the acoustic model is trained to determine the statistical representations further based on corresponding transcripts.

5. The system of claim 1, wherein the acoustic model includes Time Depth Separable convolutions and/or Transformers.

6. The system of claim 1, wherein the electronic storage stores a lexicon, wherein the decoder is based on (i) a beam-search algorithm that is based on the lexicon, and/or (ii) power of n-gram language models.

7. The system of claim 6, wherein the decoder is based on the beam-search algorithm, wherein the lexicon is based on transcripts stored in the electronic storage.

8. (canceled)

9. The system of claim 7, wherein the lexicon and the transcripts are stored in the electronic storage, wherein the one or more processors are further configured by the machine-readable instructions to store the first output transcript to the electronic storage and included the transcripts.

10. A method for end-to-end speech recognition to provide accurate transcriptions and reduced latency, the method comprising:
receiving audio information including audio signals, wherein the audio signals convey sounds that represent words spoken by a user;
effectuating an acoustic model to determine phonemes present in the sounds conveyed by the audio signals based on the audio signals and subsequently determine statistical representations based on the phonemes such that the statistical representations correspond to the phonemes, wherein the acoustic model is run on a graphical processing unit using non-conditional computation, further wherein the acoustic model being run on the graphical processing unit using the non-conditional computation includes satisfaction of conditions not being required in running the acoustic model on the graphical processing unit, wherein at least the acoustic model and the decoder stored in an electronic storage, wherein the acoustic model is trained to determine and store the statistical representations for individual sounds uttered by users, wherein individual ones of the statistical representations are numbers that represent individual phonemes in a format computable by at least the decoder, wherein the individual phonemes are units of sound that distinguish individual spoken words from other words spoken by the users, wherein the decoder is configured to determine an output transcript based on the statistical representations;
obtaining the corresponding statistical representations from the acoustic model;
effectuating the decoder to determine a first output transcript for the audio information based on the statistical representations, wherein the decoder is run on a central processing unit using conditional computation, further wherein the decoder being run on the central processing unit using the conditional computation includes satisfaction of conditions being required in running the decoder on the central processing unit; and
effectuating presentation of the first output transcript for the audio information via client computing platform associated with the user.

11. (canceled)

12. (canceled)

13. The method of claim 10, wherein the acoustic model is trained to determine the statistical representations further based on corresponding transcripts.

14. The method of claim 10, wherein the acoustic model includes Time Depth Separable convolutions and/or Transformers.

15. The method of claim 10, wherein the electronic storage stores a lexicon, wherein the decoder is based on (i) a beam-search algorithm that is based on the lexicon, and/or (ii) power of n-gram language models.

16. The method of claim 15, wherein the decoder is based on the beam-search algorithm, wherein the lexicon is based on transcripts stored in the electronic storage.

17. (canceled)

18. The method of claim 16, wherein the lexicon and the transcripts are stored in the electronic storage, further comprising storing the first output transcription to the electronic storage and included the transcripts.

19. The system of claim 1, wherein satisfaction of conditions being required in running the decoder on the central processing unit includes the decoder executing tree traversal and/or decision tree pruning.

20. The method of claim 10, wherein satisfaction of conditions being required in running the decoder on the central processing unit includes the decoder executing tree traversal and/or decision tree pruning.
